(19) United States
(12) Patent Application Publication
(10) Pub. No.: US 2006/0231699 A1
(43) Pub. Date: Oct. 19, 2006

(54) Supporting structure for display panel

(75) Inventors: Yung-Kuo Yau, Taipei (TW); Chun-Hsiung Chen, Taipei (TW)

Correspondence Address: BACON & THOMAS, PLLC, 625 SLATERS LANE, FOURTH FLOOR, ALEXANDRIA, VA, 22314, US

(73) Assignee: COMPAL ELECTRONICS, INC., Neihu (TW)

(21) Appl. No.: 11/205,071

(22) Filed: Aug. 17, 2005

(30) Foreign Application Priority Data
Feb. 24, 2005 (TW) 094202938

(51) Int. Cl. F16M 11/00

(52) U.S. Cl. 248/176.1

(57) ABSTRACT

A supporting structure for display panel comprising height adjusting mechanism and slot-sliding angle adjusting mechanism installed on the upper end of the height adjusting mechanism, when the structure is used as supporting device for LCD display panel it will enable the LCD display panel to possess the function of height adjusting and pitching angle adjusting; wherein the slot-sliding angle adjusting mechanism comprises a sliding seat, a supporting guide-block and a torque unit, and has the supporting guide block installed on the upper end of the height adjusting mechanism, the sliding seat and the supporting guide-block assembled together in such a way that the sliding seat can move in sliding manner on and relative to the supporting guide-block so that the pitching angle of the sliding seat can be adjusted by moving the sliding seat along the supporting surface of the supporting guide-block, and by employing the torque unit an appropriate fastening force is provided to hold the sliding seat in the desired position.

### BACKGROUND OF THE PRESENT INVENTION

1. Field of the Present Invention

The invention relates to a supporting structure for display panel, particularly the supporting structure for display panel equipped with slot-sliding angle adjusting mechanism which enables the LCD display panel to possess the function of height and pitching angle adjusting.

2. Description of Prior Act

Traditionally the connection between the CRT or LCD display panel and the supporting seat is achieved by means of a pivotal mechanism to form a pitching angle adjusting mechanism for the CRT or LCD to adjust its pitching angle. However, since this type of supporting seat has no height adjusting mechanism, the drawback of the traditional CRT or LCD support seat is that the height of the CRT or LCD display panel can not be adjusted, and the display panel can only be used at fixed height. This has resulted in the inconveniency that user is unable to adjust the height of the display panel according to the habit of the user and the actual condition of environment.

In order to improve the drawback of unable to adjust the height of the traditional LCD display panel, the inventor of the present invention has disclosed an invention with title of “Adjustable supporting device for a display panel” which equipped with both of the pitching angle adjusting mechanism and the height adjusting mechanism, and the invention has been granted an U.S. patent with U.S. Pat. No. 6,712,321 which enabled the LCD display panel to possess both the function of pitching angle adjusting and height adjusting.

However since this kind of Adjustable “supporting device for display panel” as mentioned above still uses pivotal mechanism as the means for achieving the function of pitching angle adjusting of LCD display panel, and normally most of the pivotal mechanism are made of metal that resulted in the drawbacks of heavy weight and high cost. In order to overcome the drawbacks the inventor disclosed a supporting structure for display-panel in the present invention which adopts the slot-sliding angle adjusting mechanism instated of the pivotal mechanism and is incorporated with the function of the height adjusting mechanism provided by the “Adjustable Supporting Device for a Display Panel” as mentioned above.

### SUMMARY OF THE PRESENT INVENTION

Therefore, based on the above, the major purpose of the invention is to provide a new supporting structure for display panel which comprises the slot-sliding angle adjusting mechanism and the height adjusting mechanism, and when the structure is used as the supporting device for LCD display panel, it can enable the LCD display panel to possess the function of pitching angle adjusting and height adjusting.

The minor purpose of the invention is to provide a slot-sliding angle adjusting mechanism which comprises a sliding seat, a supporting guide-block and a torque unit wherein the sliding seat and the supporting guide-block are assembled together in such a way that the sliding seat can move in sliding manner on and relative to the curved surface of the supporting guide-block, and a torque unit is employed to provide appropriate fastening force to hold the sliding seat in the desired angular position.

### BRIEF DESCRIPTION OF THE DRAWING FIGURES

FIG. 1 is the application drawing of the supporting structure for display panel 10 of the invention which is used as the supporting device for LCD display panel 90.

FIG. 2 is the disassembly drawing of parts of the supporting structure for display panel 10 of the invention showing that the supporting structure for display panel 10 has a slot-sliding angle adjusting mechanism 15 and height adjusting mechanism 50.

FIG. 3 is the schematic drawing of the supporting structure for display panel 10 of the invention showing that the height of the LCD display panel can be adjusted by employing the height adjusting mechanism 50 when the supporting structure for display panel of the invention is used as the supporting device for LCD display panel.

FIG. 4 is the schematic drawing of the supporting structure for display panel 10 of the invention showing that the pitching angle of the LCD display panel can be adjusted by employing the slot-sliding angle adjusting mechanism 15 when the supporting structure for display panel of the invention is used as supporting device for LCD display panel.

FIG. 5 is the enlarged sectional drawing of the slot-sliding angle adjusting mechanism 15 of the supporting structure for display panel 10 of the invention under different pitching angle showing the movement of parts and relation between parts when the slot-sliding angle adjusting mechanism 15 of the supporting structure for display panel 10 of the invention is employed to adjust the pitching angle.

### DETAILED DESCRIPTION OF THE PREFERRED EMBODIMENTS

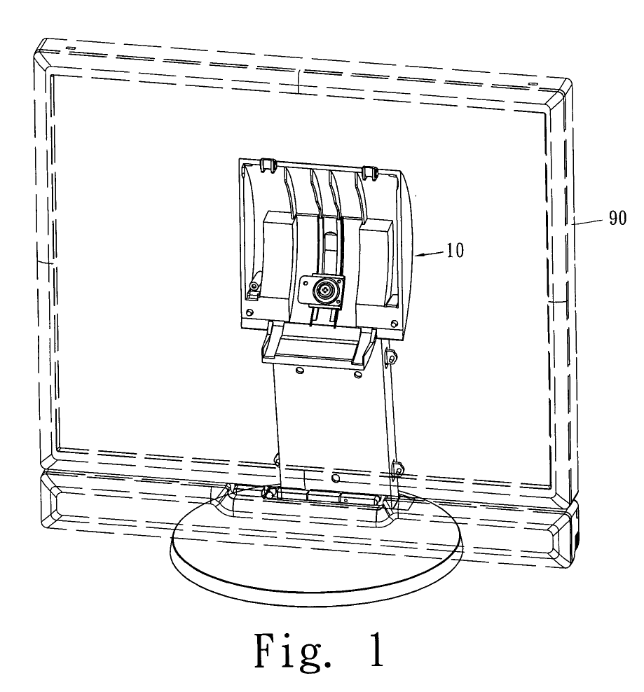

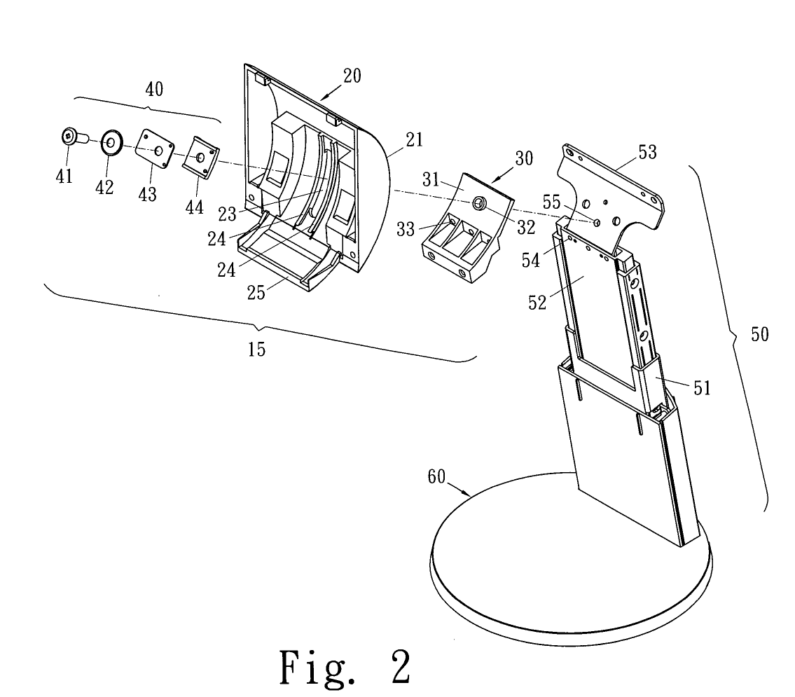

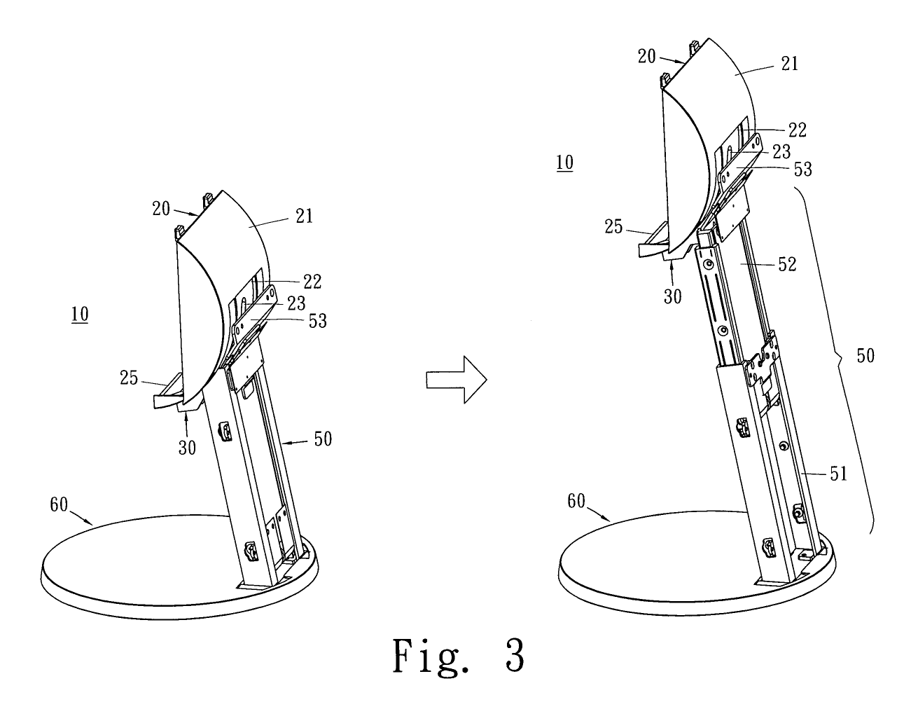

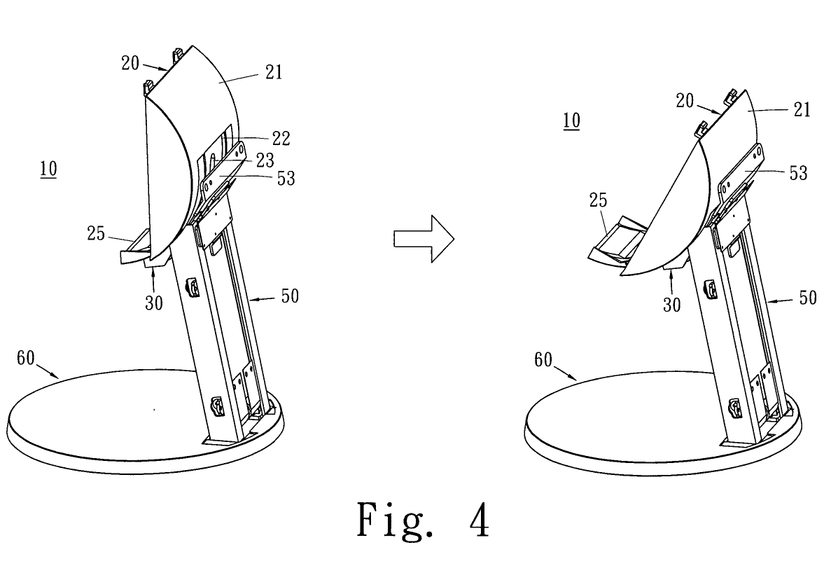

As shown in FIG. 1 the supporting structure for display panel 10 can be used as supporting device for LCD display panel 90, particularly, as shown in FIG. 2 and FIG. 3 the supporting structure for display panel 10 of the invention comprises a slot-sliding angle adjusting mechanism, a height adjusting mechanism 50 and a base seat 60, wherein the base seat 60 is for providing a firm and secure support to the LCD display panel 90 so that the LCD display panel 90 can be firmly put on a flat surface, the height adjusting mechanism 50 is for providing height adjusting function, and the slot-sliding angle adjusting mechanism 15 is for providing pitching angle [symbol] adjusting function to enable the LCD display panel 90 to possess the function of pitching angle adjusting as illustrated in FIGS. 3 and 4.

Also the structure of height adjusting mechanism 50 shown in FIGS. 3 and 4 comprises a supporting column 51 and a sliding column 52 wherein the supporting column is fixed on the base seat 60, and has an inner space for accommodating the sliding column 52 to form sleeve-sliding assembly allowing the sliding column 52 to move in sliding manner on and relative to the supporting column 51. When the sliding column 52 is moved and set at the desired height, a fastening mechanism (not shown in the drawing) installed between the supporting column 51 and the sliding column 52 can keep the sliding column 51 at the selected height, and when the position of the sliding column 52 is to be readjusted, an external force can be applied on the sliding column 52 to overcome the constraint force and move the sliding column 52 to the desired position, and then the sliding column is hold at the selected position by the fastening mechanism.

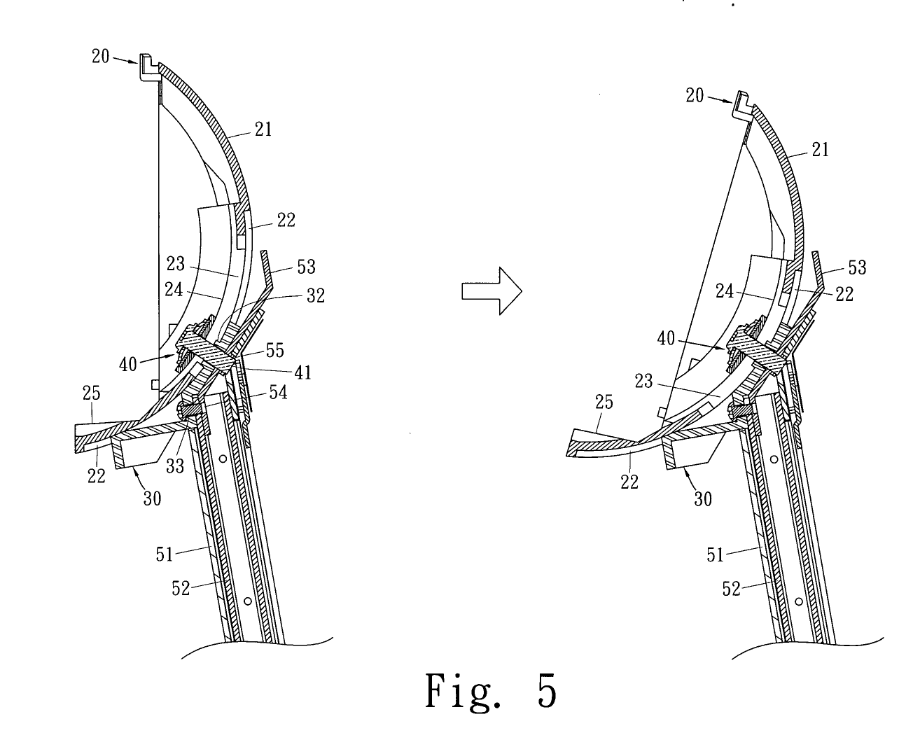

Further, as illustrated in FIGS. 2 and 5; several fastening holes 54 are provided on the upper end of the sliding column 52 of the height adjusting mechanism 50 for mounting the fixing piece 53 and the supporting guide-block 30 of the slot-sliding angle adjusting mechanism 15 by fastening screws with part of the supporting guide-block 30 overlapped on the fixing piece 53. Also on the fixing piece 53 fastening hole 55 is provided for mounting the fastening bolt 41 of the torque unit 40 of the slot-sliding angle adjusting mechanism 15.

Therefore, with the arrangement of fixing the supporting guide-block 30 on the upper end of the sliding column 52, and installing the fastening bolt 41 of the torque unit 40 on the fixing piece 53 which is mounted on the sliding column 52, the slot-sliding angle adjusting mechanism 15 and the height adjusting mechanism 50 are assembled together to form a complete unit which is positioned on the upper end of the sliding column 52. When the height of the display panel is being readjusted through the height adjusting mechanism 50, the slot-sliding angle adjusting mechanism 15 will move synchronously with the sliding column 52.

Shown in FIGS. 2, 4 and 5 is the arrangement of the slot-sliding angle adjusting mechanism 15 which comprises a sliding seat 20, a supporting guide-block 30 and a torque unit 40 wherein the sliding seat 20 and the supporting guide-block 30 are assembled together in such a way that the sliding seat 20 can move in sliding manner on and relative to the supporting guide block 30 for adjusting the pitching angle, and the torque unit 40 can be employed to provide appropriate fastening force to hold the sliding seat 20 at the desired pitching angle, and when the pitching angle of the sliding seat 20 is to be readjusted, appropriate force can be applied on the sliding seat 20 to overcome the restraint force exerted by the torque unit 40 to move the sliding seat 20 to the desired angle.

The back surface 21 of the sliding seat 20 is formed into curved surface, and an auxiliary plate 25 having the same surface curvature as that of the back surface 21 of the sliding seat 20 is formed and extended from the lower edge of the back surface 21. Also shown in FIGS. 4 and 5 the back surface 21 of the sliding seat 20 and the back surface of the auxiliary plate 25 jointly form a recess of specific shape which defines a curved sliding way 22. Besides, a guide-slot 23 is formed on the curved sliding way 22 penetrating the sliding seat 20, and along both sides of the guide slot 23 on the sliding seat 20 two curved ribs 24 are formed.

The supporting guide-block 30 has curved surface 31 which is in a curvature the same as that of the curved sliding way 22 on the back surface 21 of the sliding seat 20, and the width of the curved surface 31 is slightly smaller than the width of the curved sliding way 22, therefore, as depicted in FIGS. 4 and 5 when the supporting guide-block 30 and the sliding seat 20 are assembled together, the supporting guide-block 30 is fitted into the curved sliding surface 22 on the sliding seat 20, and forms a sliding mechanism jointly with the curved sliding surface 22 on the sliding seat 20 that enables the sliding seat 20 to move in sliding manner on the supporting guide-block 30 to achieve the function of pitching angle adjustment.

The purpose of incorporating the auxiliary plate 25 into the structure of the sliding seat 20 is to increase the range of pitching angle adjustment of the sliding seat 20 and to increase the contact surface area between the sliding seat 20 and the supporting guide-block 30 to better distribute the weight of the sliding seat 20 and the LCD panel display carried by the supporting guide-block 30 so as to obtain a firm supporting condition through the height adjusting mechanism and the base seat 60.

As shown in FIGS. 2 and 5, a raised guide-hub 32 is formed on the curved surface 31 of the supporting guide-block 30. When the sliding seat 20 and the supporting guide-block 30 are assembled together to form a sliding mechanism, the raised guide-hub 32 is fitted into the guide-slot 23 on the sliding seat 20, and the assembly of the raised guide-hub and the guide-slot 23 on the sliding seat 20 forms another sliding mechanism in which the sliding stroke defined by the length of the guide-slot 23 forms the limit of the range of adjustment of the pitching angle of the sliding seat 20.

On the supporting guide block several penetrating holes 33 are provided and positioned corresponding to the fastening holes 54 on the upper end of the sliding column 52 of the height adjusting mechanism 50. Also, a penetrating hole is formed inside the raised guide-hub 32, and is positioned corresponding to the fastening hole 55 on the fixing piece 53 formed on the upper end of the sliding column 52 of the height adjusting mechanism 50. With the arrangement when the supporting guide-block 30 is fastened on the upper end of the sliding column 52 by fastening screw, the penetrating hole of the raised guide-hub 32 on the supporting guide-block 30 will automatically coincide with the fastening hole 55 on the fixing piece 53 for mounting the fastening bolt 41 of the torque unit 40.

As shown in FIGS. 1, 2 and 5, the torque unit 40 comprises a screw 41, a disk plate spring 42, a clamping plate 43 and a sliding guide-plate 44 wherein the bottom side of the sliding guide-plate 44 is a curved surface with curvature same as the curvature of the curved rib 24 on both sides of the guide-slot 23 on the sliding seat 20. Therefore, when the sliding guide-plate 44 is installed on and crossing the two curved ribs 24 friction surface is formed between the bottom surface of the sliding guide-plate 44 and the tope surface of the two-curved ribs 24. The pressure force exerted by the disk plate spring 42 on the sliding guide-plate 44 will generate static friction force to achieve the effect of fixing the sliding seat in the selected position. Further, in order to have the force of the disk plate spring uniformly distributed on the sliding guide-plate 44 the top side of the sliding guide-plate 44 is formed into a flat surface for mounting the clamping plate 43 which also has flat top surface and flat bottom surface.

Finally, the torque unit 40 is installed by having the fastening bolt 41 to pass through the disk plate spring 42, clamping plate 43, sliding guide-plate 44, guide slot 23 on sliding seat 20, raised guide hub 32, and than fixed in the fastening hole 55 on the fixing piece 53 of the height adjusting mechanism 50. With this arrangement not only the slot-sliding angle adjusting mechanism 15 can be firmly installed on the upper end of the sliding column 52 of the height adjusting mechanism but also the torque unit 40 can be assemble to provide appropriate fastening force to allow the sliding seat 20 to move in sliding manner to achieve the function of pitching angle adjusting as well as to hold the sliding seat 20 at the angular position selected by the user.

Although the invention has been described in its preferred form as shown in the above, it is understood that modifications, changes, improvements or alternations which have the effect equivalent to or same as the effect of the present invention, and are apparent to those skilled in the art shall be covered by the appended claims.

What is claimed is:

1. A supporting structure for display panel applicable for height and pitching angle adjustment to a display panel unit comprising a base seat, a height adjusting mechanism and a slot-sliding angle adjusting mechanism wherein:
the base seat is provided for mounting and carrying the height adjusting mechanism, and being suitably placed on a flat surface firmly;
the height adjusting mechanism comprises a supporting column fixed on the base seat, and a sliding column fitted into inner space of the supporting column to form a sleeve-sliding connection, and capably moved in sliding manner on and relative to the supporting column to achieve a height adjustment; and
the slot-sliding angle adjusting mechanism is installed on the upper end of the sliding column of the height adjusting mechanism, which comprising
a sliding seat with a curved back surface and a guide-slot formed on and penetrating through the sliding seat to limit a sliding stroke to the sliding seat;
a supporting guide-block fixed on the sliding column of the height adjusting mechanism with a curved supporting surface to fit with the curved back surface of the sliding seat for moving in sliding manner on and relative to the sliding seat; and
a torque unit fastened on the height adjusting mechanism to provide a fastening force against the sliding seat.

2. The supporting structure for display panel as described in claim 1, wherein an auxiliary plate having a surface curvature same as that of curved back surface of the sliding seat is formed on and extended from the lower edge of curved back surface of the sliding seat.

3. The supporting structure for display panel as described in claim 1, wherein a raised guide-hub is formed on the supporting guide-block, and is fitted into the guide-slot of the sliding seat.

4. The supporting structure for display panel as described in claim 1, wherein a fixing piece is formed on the sliding column of the height adjusting mechanism.

5. The supporting structure for display panel as described in claim 1, wherein the supporting guide-block is fixed on the fixing piece of the height adjusting mechanism through a fastening bolt.

6. The supporting structure for display panel as described in claim 1, wherein on back side of the sliding seat two curved ribs are respectively formed along both sides of the guide-slot of the sliding seat.

7. The supporting structure for display panel as described in claim 1, wherein the torque unit comprises a fastening bolt, a disk plate spring and a sliding guide-plate, particularly the fastening bolt is used to pass through the disk plate spring, the sliding guide-plate, the guide-slot on the sliding seat and the supporting guide-block, and is fixed on the height adjusting mechanism to enable the disk plate spring and the sliding guide-plate to exert fastening force against the sliding seat.

8. The supporting structure for display panel as described in claim 7, wherein the torque unit further comprises a clamping plate installed between the disk plate spring and the sliding guide-plate.

9. The supporting structure for display panel as described in claim 7, wherein the sliding guide-plate of the torque unit is mounted crossing the two curved ribs of the sliding seat.

10. The supporting structure for display panel as described in claim 1, wherein the height adjusting mechanism has a positioning mechanism installed between the supporting column and the sliding column for holding the sliding column at the selected height.
